(19) United States
(12) Patent Application Publication
(10) Pub. No.: US 2005/0248181 A1
(43) Pub. Date: Nov. 10, 2005

(54) Trim pad assembly having a support channel

(76) Inventor: Michael Bigelow, New Baltimore, MI (US)

Correspondence Address: David J. Simonelli, Esq.;Clark Hill PLC, Suite 3500, 500 Woodward Ave., Detroit, MI, 48226-3435, US

(21) Appl. No.: 10/840,717

(22) Filed: May 6, 2004

(51) Int. Cl. B60J 5/00

(52) U.S. Cl. 296/146.7

(57) ABSTRACT

A trim pad assembly covers a watershield and a door frame of an automobile. The automobile includes a passenger compartment accessible via the door frame. The door frame defines an inboard door contour. The trim pad assembly includes an inboard decorative surface facing the passenger compartment when the door frame is in the closed position. The trim pad assembly also includes an outboard surface defining a periphery and a trim pad contour. The periphery is fixedly secured to the door frame. The trim pad contour differs from the inboard door contour. A support channel is fixedly secured to the outboard surface and extending outwardly therefrom. The support channel defines a support contour that compliments the inboard door contour such that the watershield is fixedly secured to the support channel and seals the watershield against the door frame.

### BACKGROUND ART

1. Field of the Invention

The invention relates to a trim pad assembly for a vehicle door. More particularly, the invention relates to a trim pad assembly incorporating an offset disposed between the trim pad and a watershield to create a positive seal between the watershield and a door frame of an automobile.

2. Description of the Related Art

Automobiles include doors that have trim pads covering the inboard surface of the door. The trim pads are decorative and are usually fabricated of the same material as the interior upholstery or carpet of the automobile. While it may appear that the trim pad has the sole purpose of being decorative, the trim pad assembly has a multi-functioning task. The trim pad must be aesthetically pleasing to the operator of the automobile. In addition, the trim pad is used to reduce road noise. Still another function of the trim pad assembly is to prevent the elements from passing through the door and into the passenger compartment. The trim pad assembly covers the door and, more particularly, the door frame, that has several apertures extending therethrough allowing for the mounting and accessing of subsystems within the door.

A watershield is used to prevent water and other debris from passing between the door frame to a trim pad. The watershield is typically sealed against the door frame to ensure the trim pad is not damaged by material that finds its way into the door frame. A problem associated with a watershield extending between a trim pad and a door frame is the fact that the trim pad and door frame typically do not have the same contours. This makes it difficult to seal a trim pad mounted watershield against a door frame. This is especially true when the trim pad and the vehicle door are already designed and differ in contour. When the contour of the trim pad does not meet the contour of the door frame, adhesive is the only means for securing the trim pad to the door frame. Sealing the watershield against the door frame by forcing an adhesive bead or strip on the watershield into the door frame is a much more effective way of sealing the door frame with the watershield, especially when resealing the watershield after a situation when the watershield must be partially or fully separated from the door frame so as to service that which is behind the watershield.

### SUMMARY OF THE INVENTION

A trim pad assembly covers a watershield and a door frame of an automobile. The automobile includes a passenger compartment accessible via the door frame. The door frame defines an inboard door contour. The trim pad assembly includes an inboard decorative surface facing the passenger compartment when the door frame is in the closed position. The trim pad assembly also includes an outboard surface defining a periphery and a trim pad contour. The periphery is fixedly secured to the door frame. The trim pad contour differs from the inboard door contour. A support channel is fixedly secured to the outboard surface and extending outwardly therefrom. The support channel defines a support contour that complements the inboard door contour such that the watershield is fixedly secured to the support channel and seals the watershield against the door frame.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 a perspective view of a passenger compartment of an automobile with a door incorporating one embodiment of the invention;

FIG. 2 is a side view of an outboard surface of the trim pad assembly incorporating one embodiment of the invention;

FIG. 3 is an exploded perspective view of the invention incorporated into a door frame;

FIG. 4 is a cross-sectional side view of a door frame incorporating one embodiment of the invention; and

FIG. 5 is a cross-sectional side view partially cutaway, of one embodiment of the invention.

### DETAILED DESCRIPTION OF THE PREFERRED EMBODIMENT

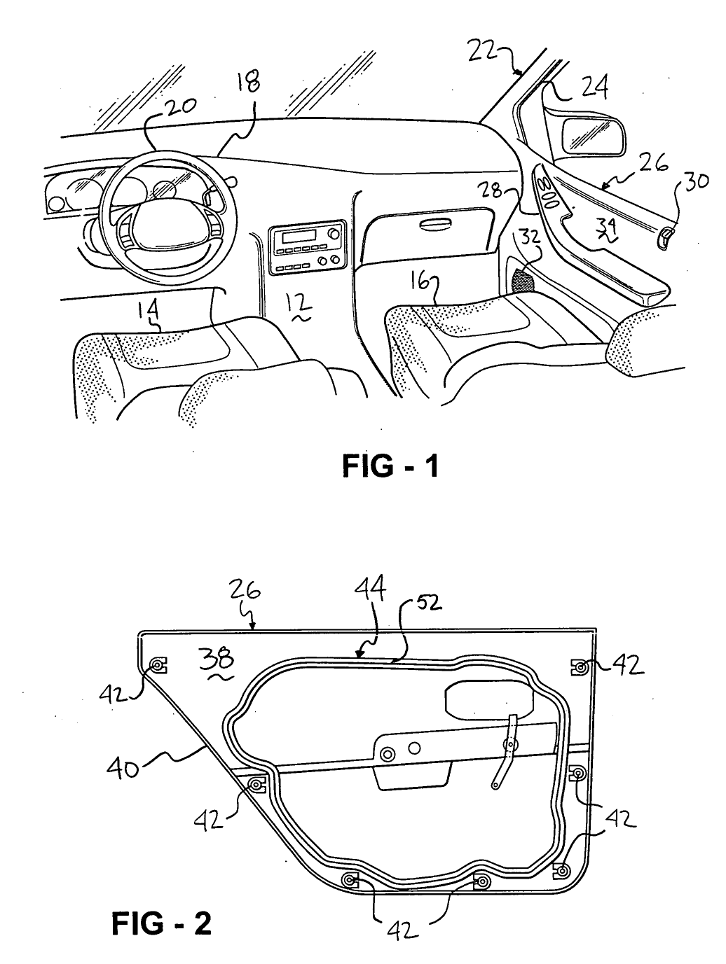

Referring to the FIG. 1, a perspective view of an automobile is generally indicated at 10. The automobile 10 includes a passenger compartment 12 having a driver's seat 14 and a passenger seat 16. The passenger compartment 12 also includes an instrument panel 18 and a steering wheel 20. Access to the passenger compartment 12 is provided by a door 22 that includes a door frame 24. As is known in the art, the door 22 is selectively opened and closed to provide access to the passenger compartment 12.

The door 22 also includes a trim pad assembly 26. The trim pad assembly 26 has a door handle/arm rest 28 fixedly secured thereto. Additional subsystems of the automobile 10 that are secured to the door 22 and have access through the trim pad assembly 26 include a door lock knob 30 and a speaker 32. As should be appreciated by those skilled in the art, there may be several other types of subsystems that are secured to the door frame 24 and are covered by or extend through the trim pad assembly 26.

The trim pad assembly includes an inboard decorative surface 34. The inboard decorative surface typically includes a cover of the same material or fabric that is used throughout the passenger compartment 12. For aesthetic reasons, the inboard decorative surface 34 is typically not fabricated from a material that will provide a shield from water and any other type of dirt or debris that might be collected within the door frame 24 of the door 22.

Referring to FIG. 2, the trim pad assembly 26 includes a trim pad 36. The inboard decorative surface 34 defines one surface of the trim pad 36. Another surface of the trim pad 36 is the outboard surface 38. Because the trim pad 36 is fabricated from an injection molded polypropylene or polyurethane, the outboard surface 38 typically has a similar contour to the inboard decorative surface 34. The outboard surface 38 faces the door frame 24 of the door 22.

The outboard surface 38 defines a periphery 40 extending thereabout. A plurality of fasteners 42 are spaced about the periphery 40 and are used to secure the trim pad 36 to the door frame 24. In the preferred embodiment shown in FIG. 2, the fasteners 42 are screws.

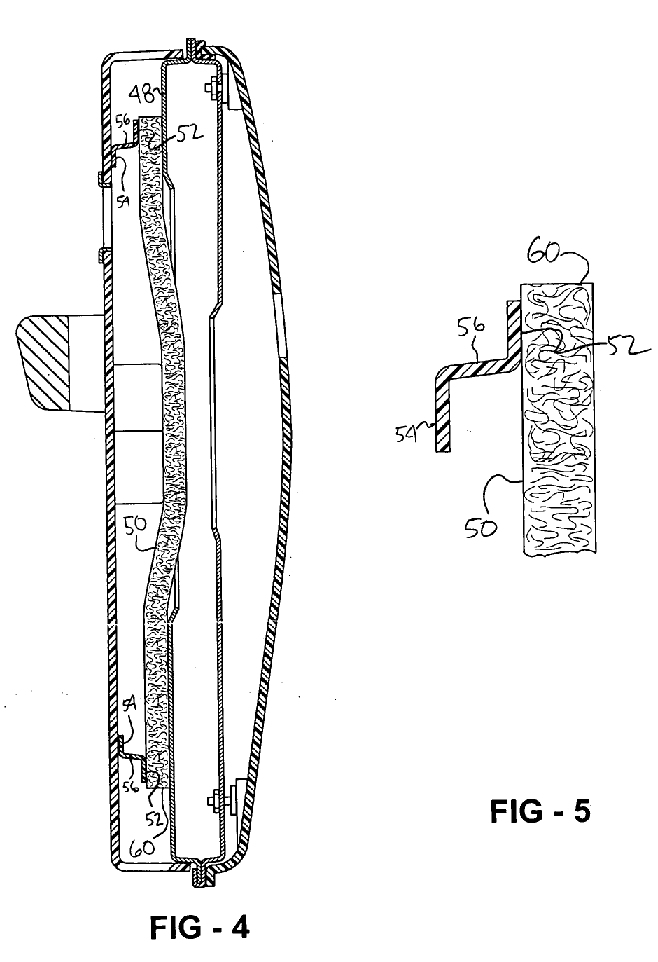

The trim pad assembly 26 includes a support channel, generally shown at 44. The support channel 44 is fixedly secured to the outboard surface 38 of the trim pad 36. In one embodiment, the support channel 44 is heat staked to outboard surface 38. The support channel 44 extends outwardly from the outboard surface 38 toward the door frame 24. The support channel 44 defines a support contour 46. The support contour 46 complements the inboard door contour 48 (best seen in FIG. 4) of the door frame 24. The support channel 44 is used for trim pad 36 having contour differences with the inboard contour of the door frame 24.

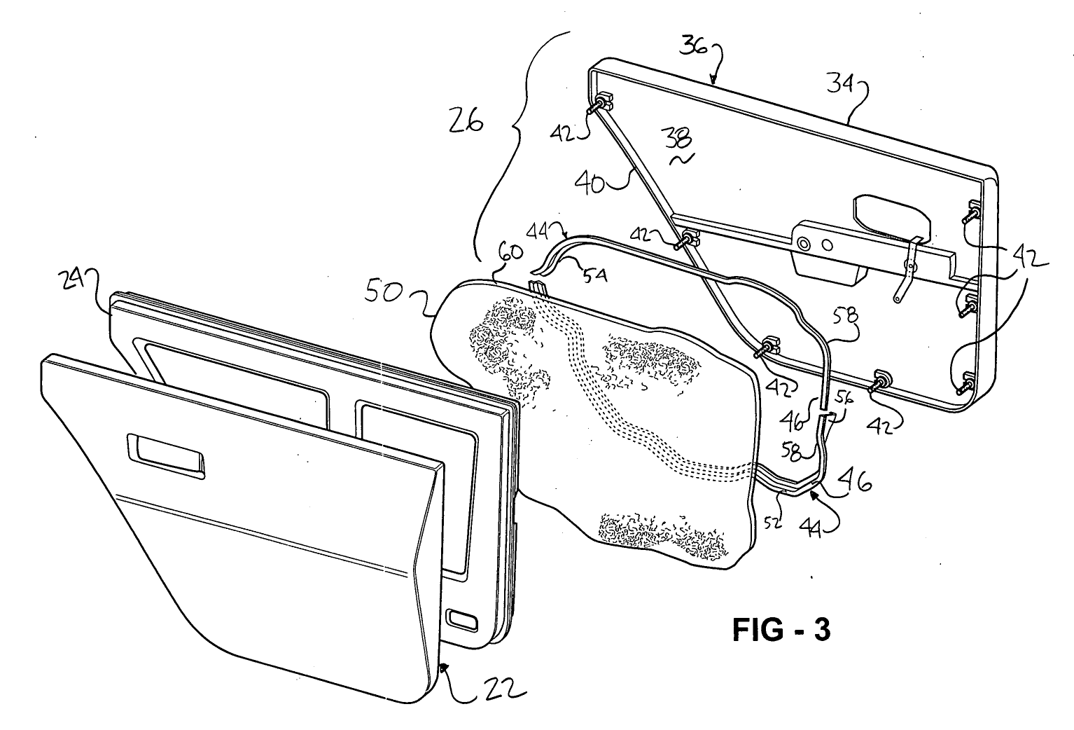

Referring to FIGS. 3 through 5, a watershield 50 extends between the outboard surface 38 of the trim pad 36 and the door frame 24. More specifically, the watershield 50 is in sealing engagement with the door frame 24 due to pressure exerted on it by the support channel 44 that extends out from the outboard surface 38 of the trim pad 36. The watershield 50 may extend across an entire surface defined by the trim pad 36 or merely a portion thereof. The watershield 50 prevents water and other debris from passing through the door 22 and reaching the trim pad 36.

The support channel 44 includes a support surface 52 for securing the watershield 50 thereagainst. The support channel 44 also includes a base 54 which is fixedly secured to the outboard surface 38 of the trim pad 36. An extension portion 56 extends between the base 54 and the support surface 52 of the support channel 44. The support channel 44 is Z-shaped in the preferred embodiment. It should be appreciated that the extension portion 56 may extend from the base 54 to the support surface 52 in any number of ways.

The extension portion 56 has a varying width. The width is defined by the space between the outboard surface 38 of the trim pad and the inboard door contour 48. As the spacing between these two surfaces changes, the width of the extension portion 58 must also change to ensure that the watershield 50 has a constant force applied against it toward the door frame 24 in a uniform and consistent manner.

In the embodiment shown in the Figures, the support channel 44 is fabricated from a plurality of channel pieces 58. There are two channel pieces 58 shown in FIG. 3. Depending on the configurations of the trim pad 36 and the door frame 24, there may be several channel pieces 58 used to create the support channel 44 to effectively apply pressure along all of the watershield 50 to ensure the watershield 50 is physically sealed against the door frame 24. The support channel 44 extends through a curved path that is substantially similar to a periphery 60 of the watershield 50. This minimizes issues relating to weight and obstruction of the subsystems in the door 22.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

1. A trim pad assembly for covering a watershield and a door frame of an automobile having a passenger compartment accessible via the door frame wherein the door frame defines an inboard door contour, said trim pad assembly comprising:
an inboard decorative surface facing the passenger compartment when the door frame is in a closed position;
an outboard surface defining a periphery and a trim pad contour, said periphery fixedly secured to the door frame, said trim pad contour differing from said inboard door contour; and
a support channel fixedly secured to said outboard surface and extending outwardly therefrom, said support channel defining a support contour complementing the inboard door contour such that the watershield is fixedly secured to said support channel sealing the watershield against the door frame.

2. A trim pad assembly as set forth in claim 1 wherein said support channel includes a support surface for securing the watershield thereagainst.

3. A trim pad assembly as set forth in claim 2 wherein said support channel includes a base fixedly secured to said inboard decorative surface.

4. A trim pad assembly as set forth in claim 3 wherein said support channel includes an extension portion extending between said base and said support surface.

5. A trim pad assembly as set forth in claim 2 wherein said extension portion defines a varying width.

6. A trim pad assembly as set forth in claim 3 wherein said support channel is fabricated from a plurality of channel pieces.

7. A trim pad assembly as set forth in claim 4 wherein said support channel is heat staked to said inboard decorative surface.

8. A trim pad assembly for covering a door frame of an automobile having a passenger compartment accessible via the door frame wherein the door frame defines an inboard door contour, said trim pad assembly comprising:
an inboard decorative surface facing the passenger compartment when the door frame is in a closed position;
an outboard surface defining an outboard surface periphery and a trim pad contour, said periphery fixedly secured to the door frame, said trim pad contour differing from said inboard door contour;
a watershield defining a watershield periphery smaller than said outboard surface periphery; and
a support channel fixedly secured to said outboard surface and extending outwardly therefrom, said support channel defining a support contour complementing the inboard door contour such that said watershield is fixedly secured to said support channel sealing said watershield against the door frame.

9. A trim pad assembly as set forth in claim 8 wherein said support channel extends through a curved path substantially similar to said watershield periphery.

10. A trim pad assembly as set forth in claim 9 wherein said support channel includes a support surface for securing said watershield thereagainst.

11. A trim pad assembly as set forth in claim 10 wherein said support channel includes a base fixedly secured to said inboard decorative surface.

12. A trim pad assembly as set forth in claim 11 wherein said support channel includes an extension portion extending between said base and said support surface.

13. A trim pad assembly as set forth in claim 12 wherein said extension portion defines a varying width.

14. A trim pad assembly as set forth in claim 13 wherein said support channel is fabricated from a plurality of channel pieces.

15. A trim pad assembly as set forth in claim 14 wherein said support channel is heat staked to said inboard decorative surface.

16. A trim pad assembly for covering a door frame of an automobile having a passenger compartment accessible via the door frame wherein the door frame defines an inboard door contour, said trim pad assembly comprising:
an inboard decorative surface facing the passenger compartment when the door frame is in a closed position;
an outboard surface defining an outboard surface periphery and a trim pad contour, said periphery fixedly secured to the door frame, said trim pad contour differing from said inboard door contour;
a watershield defining a watershield periphery smaller than said outboard surface periphery; and
a plurality of support channels fixedly secured to said outboard surface and extending outwardly therefrom, each of said plurality of support channels defining a support contour complementing the inboard door contour such that said watershield is fixedly secured to said plurality of support channels sealing said watershield against the door frame.

17. A trim pad assembly as set forth in claim 8 wherein said plurality of support channels extend through a curved path substantially similar to said watershield periphery.

18. A trim pad assembly as set forth in claim 9 wherein each of said plurality of support channels includes a support surface for securing said watershield thereagainst.

19. A trim pad assembly as set forth in claim 10 wherein each of said plurality of support channels includes a base fixedly secured to said inboard decorative surface.

20. A trim pad assembly as set forth in claim 11 wherein each of said plurality of support channels includes an extension portion extending between said base and said support surface.
